(19) United States
(12) Patent Application Publication
(10) Pub. No.: US 2009/0094268 A1
(43) Pub. Date: Apr. 9, 2009

(54) ANIMATED DATA FEEDS

(75) Inventors: Michael Nicholson, Sunnyvale, CA (US); David Wright, Oakland, CA (US); Michael Pow, Los Altos, CA (US); Dennis Quintela, San Francisco, CA (US); Deep Varma, Fremont, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/867,211

(22) Filed: Oct. 4, 2007

(51) Int. Cl. G06F 7/00

(52) U.S. Cl. 707/102; 707/E17.044

(57) ABSTRACT

A backend component of a website including an embedded transactional database, the embedded transactional database containing data, an adapter object, the adapter object having a plurality of application programming interfaces configured to provide interaction with the data contained within the embedded transactional database.

### BACKGROUND OF THE INVENTION

1. Field of the Invention

This invention relates to website components, more specifically, to backend components of websites.

2. Description of the Known Technology

Websites found on either a local network or on a distributed network, such as the Internet, generally include the following three components: data, a front end component having a user interface, and an intermediary software component for linking the front end component to the data. As a user interacts with the user interface of the front end component, the intermediary software component will request data relating to the user's interaction with the user interface. This requested data will then be provided to the user via the front end.

The data is generally aggregated from a variety of different sources including static databases as well as dynamic data feeds. Even for the simplest websites, the developers of the website have to maintain the data used to power the website. This maintenance of the data adds significant effort and complexity at every stage of the development of websites. Furthermore, this nearly identical work of maintaining the data for each website development project is disposed of at the end of each website development project.

Adding even more complexity to website development is the fact that as data is collected and maintained, new functionalities may be possible based on newly collected data. In order to take advantage of these new functionalities, website developers would need to modify the intermediary software component.

### BRIEF SUMMARY OF THE INVENTION

In overcoming the drawbacks of the prior art, a website component, more specifically, a backend component of a website and method for making and using the same is described. The backend component includes an embedded transactional database and an adapter object. The embedded transactional database contains data, while the adapter object includes a plurality of application programming interfaces (“APIs”) configured to provide interaction with the data contained within the embedded transactional database.

By having an adapter object in communication with an already assembled embedded transactional database, all that needs to be created is the front end component that will interact with the APIs of the adapter object. As stated in the background section, even for the simplest websites, website developers would have to maintain the data used to power the website. This maintenance of the data would add significant effort and complexity to every stage of the development of the website. By creating a simplified backend component containing the embedded transactional database and an adapter object, third party website developers can simply design the front end component to interact with the APIs of the adapter object and avoid expending resources to further develop and maintain the data used to power the website.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a network incorporating a backend component embodying the principles of the present invention;

FIG. 2 is a block diagram of the backend component embodying the principles of the present invention;

FIG. 3 is a block diagram of the backend component and a front end component embodying the principles of the present invention;

FIG. 4 illustrates a method for creating the backend component of FIG. 2; and

FIG. 5 is a block diagram of an embedded transactional database embodying the principles of the present invention;

FIG. 6 illustrates a method for creating the embedded transactional database of FIG. 5; and

FIG. 7 illustrates a method for utilizing an adapter component of the backend component.

### DETAILED DESCRIPTION OF THE INVENTION

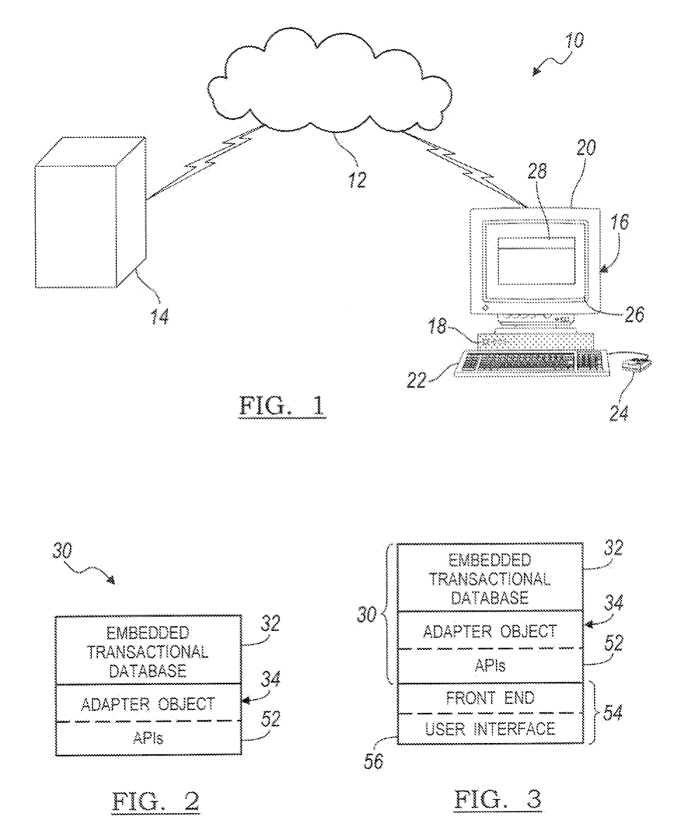

Referring to FIG. 1, a system 10 incorporating a backend component for a website is shown. The system 10 generally includes a distributed network 12, such as the internet, but may be incorporated on any time of computer network, such as a local area network or a wide area network. The distributed network 12 connects a web server 14 to a client computer 16. The web server 14 may be a general purpose computer capable of being connected to the distributed network 12. The web server 14 includes at least one processor in communication with at least one storage device. It should be understood that the web server 14 may be a single computer system or may be a combination of a plurality of computer systems in communication with each other via a wired or wireless connection.

The client computer 16 may be a general purpose personal computer, but may be any networked electronic device. Generally, the client computer 16 includes processing unit 18 in communication with a display device 20 and one or more input devices. The processing unit 18 generally includes a processor connected to a memory unit containing instructions and one or more storage devices. The display device 20 includes a display area 26. The input devices may be in the form of an analog input device such as a mouse 24 or a keyboard 22.

The display area 26 of the display device 20 is capable of displaying a website 28. Information for displaying the website 28 and conveying any information to a user of the client computer 16 originates from the web server 14. The information from the web server 14 is transmitted to the client computer 16 via the distributed network 12.

Referring to FIG. 2, a block diagram of the backend component 30 is shown. The backend component 30 in the illustrated embodiment includes two primary components: an embedded transactional database 32 and an adapter object 34. The embedded transactional database 32 is a database that does not run as a separate process, instead, it is directly linked or embedded into the backend component 30.

Referring to FIGS. 5 and 6, a brief explanation of the embedded transactional database 32 and a method for making the embedded transactional database 32 will be described. As shown in FIG. 5, the embedded database 32 is a collection of data from a variety of sources including static databases 38 or data feeds 40.

With special attention to FIG. 6, a method 42 for creating the embedded transactional database 32 is shown. The method 42 is essentially a feed processing method that collects data from a variety of sources and places them within the embedded transactional database 32. The method 42 begins with step 44, wherein data is fetched from a plurality of sources. As stated previously, the plurality of sources may include static databases 38 and/or data feeds 40.

Once the data is fetched, the data is placed into a neutral format, as shown in step 46. Essentially, by converting the data to a neutral format, algorithms can be more easily implemented to retrieve data previously fetched. By placing the data in a standardized, neutral format, simple algorithms can be designed to maintain the embedded transactional database 32 and retrieve any requested data.

In step 48, any duplicative data is removed, so as to remove unnecessary data, thereby keeping the embedded transactional database 32 as small as possible. Finally, in step 50, the remaining data is stored within the embedded transactional database 32. The method 42 may be executed only once or may be executed on a periodic basis. For example, the method 42 may execute during off-peak hours of low activity. By executing the method 42 during off-peak hours, more computational resources may be available so that data can be more quickly assembled and stored within the embedded transactional database 32.

Referring back to FIG. 2, the adapter object 34 is in communication with the embedded transactional database 32. The adapter object 34 is essentially a PHP adapter file containing a plurality of APIs. The PHP adapter file maps and translates the data in the embedded transactional database 32 to the web service requests. This PHP adapter file takes in configuration settings that establish the proper mappings. Different PHP adapter files can be used to provide alternate mappings or web service request calls as well as different output structure (hierarchy & layout) and different formats (XML, JSON, CSV). The adapter object 34 is configured to retrieve data located within the embedded transactional database 32. Any requests for data located within the embedded transactional database 32 is made by the APIs 52. Any data retrieved by the adapter object 34 will be outputted in an XML format.

The APIs are generally representational state transfer (“REST”) components. REST is a style of software architecture for distributed hypermedia systems such as the World Wide Web. As it is well known to those skilled in the art, REST refers to a collection of network architecture principles that outline how resources are defined and addressed.

To be more specific, REST is an approach for getting information content from a Web site by reading a designated Web page that contains an XML file that describes and includes the desired content. For example, REST could be used by a website developer to make syndicated content available. Periodically, the developer would prepare and activate a Web page that included content and XML statements that described the content. Subscribers would need only to know the Uniform Resource Locator for the page where the XML file was located, read it with a Web browser, interpret the content data using the XML information, and reformat and use it appropriately.

Referring to FIG. 3, the backend component 30 is in communication with a front end component 54. The front end component includes a user interface 56, so that a user of the client computer 16 of FIG. 1 is capable of interfacing with the front end component 54. The front end component 54 is then capable of accessing data stored within the embedded transactional database via the APIs 52 of the adapter object 54.

By creating a backend component 30 with an adapter object 34 in communication with an already assembled embedded transactional database 32, all that needs to be created is the front end component 54 having the user interface 56. As stated in the background section, even for the simplest websites, website developers would have to maintain the data used to power the website. This maintenance of the data would add significant effort and complexity to every stage of the development of the website. By creating a simplified backend component 30 containing both the embedded transactional database and an adapter object 34 with APIs 52 that could be easily accessed by a front end 54, third parties can simply design the front end component and the user interface and avoid the trouble of spending significant amounts of time and effort developing and maintaining the data used to power the website.

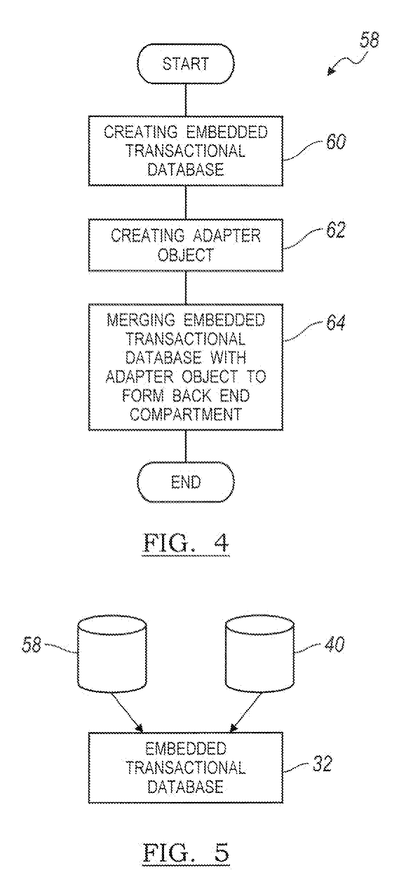

Referring to FIG. 4, a method for creating the backend component 30 of FIG. 2 is shown. In step 60, the embedded transactional database is created. The steps for creating the embedded transactional database were previously described in the method 42 of FIG. 6. Thereafter, in step 62, an adapter object is created. Generally, the adapter object can be created using a PHP interface. Afterwards, in step 64, the adapter object and the embedded transactional database are merged to form the backend component 30.

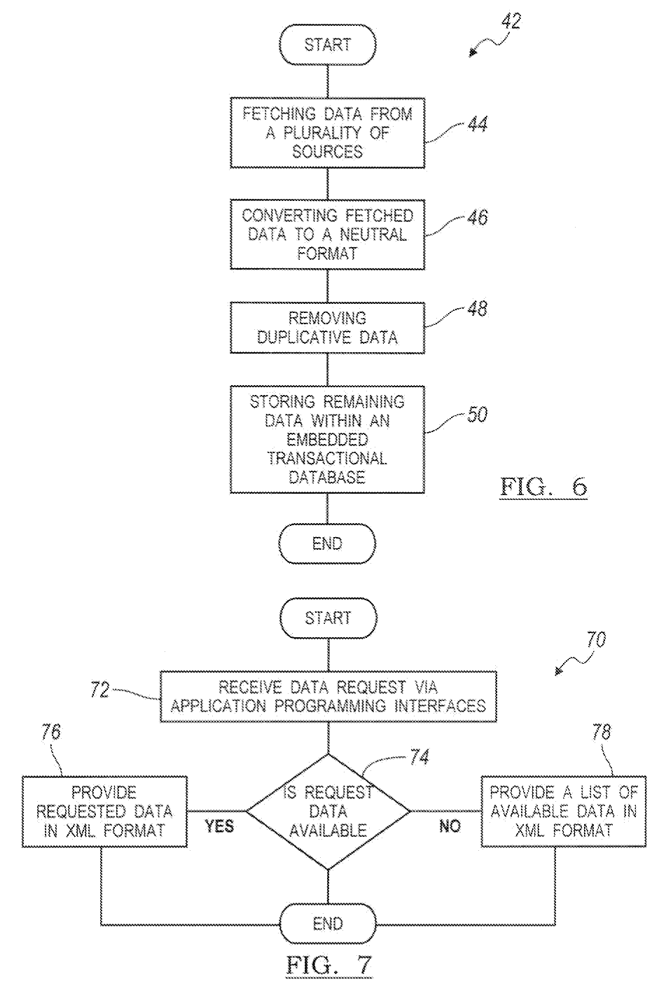

In an effort to make it as easy as possible for third parties to develop front end components, the adapter object of FIG. 4 is configured to output data in XML format or a list of available data in XML format if the data request is not proper. For example, as shown in FIG. 7, a method 70 for providing data from the embedded transactional database 32 of FIG. 2 is shown. In step 72, the adapter object 34 receives a request from the APIs 52 for data. The adapter object 34, in step 74 determines if the requested data is available. If the requested data is available, the adapter object 34 will provide the requested data in XML format as shown in step 76. Otherwise, as shown as step 78 the adapter object 34 will provide a list of available data in XML format. By providing a list of available data in XML format if the request data is not available, the third party developers can more easily develop front end components to utilize the backend component 30.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for creating a backend component for a website, the method comprising:
creating an embedded transactional database, the embedded transactional database containing data;
creating an adapter object, the adapter object having a plurality of application programming interfaces configured to provide interaction with the data contained within the embedded transactional database; and
merging the embedded transactional database with the adapter object to form the backend component for the website.

2. The method of claim 1, wherein the step of creating the transactional database further comprises the steps of:
fetching new data from a plurality of sources;
converting the new data to a neutral format; and
storing the new data within the embedded transactional database.

3. The method of claim 2, further comprising the step of selecting new data to fetch from the plurality of sources based on data requests made via the application programming interfaces of the adapter object.

4. The method of claim 1, further comprising the steps of:
receiving request for data via the application programming interfaces of the adapter object;
determining if the requested data is located within the embedded transactional database; and
providing the requested data in an extensible markup language format if the requested data is located within the embedded transactional database.

5. The method of claim 4, further comprising the step of providing a list of available data in the extensible markup language format if the requested data is not located within the embedded transactional database.

6. The method of claim 1, further comprising the step of creating a front end component for the website, the front end component being configured to utilize the application programming interfaces of the adapter object to interact with the data contained within the embedded transactional database.

7. The method of claim 6, wherein the step of creating the front end is performed by a third party.

8. The method of claim 1, wherein the application programming interfaces are representational state transfer components.

9. A backend component of a website, the backend component comprising:
an embedded transactional database, the embedded transactional database containing data;
an adapter object, the adapter object having a plurality of application programming interfaces configured to provide interaction with the data contained within the embedded transactional database; and
wherein the embedded transactional database and the adapter object form the backend component for the website.

10. The system of claim 9, wherein the embedded transactional database further comprises data stored in a neutral format

11. The system of claim 10, further wherein the data stored in the embedded transactional database is related to data requests made via the application programming interfaces of the adapter object.

12. The system of claim 9, wherein the application programming interfaces of the adapter object is configured to determine if the requested data is located within the embedded transactional database and provide the requested data in an extensible markup language format if the requested data is located within the embedded transactional database.

13. The system of claim 12, wherein the application programming interfaces of the adapter object is configured to provide a list of available data in the extensible markup language format if the requested data is not located within the embedded transactional database.

14. The system of claim 9, further comprising a front end component for the website, the front end component being configured to utilize the application programming interfaces of the adapter object to interact with the data contained within the embedded transactional database.

15. The system of claim 9, wherein the application programming interfaces are representational state transfer components.
